(19) United States
(12) Patent Application Publication
(10) Pub. No.: US 2017/0213673 A1
(43) Pub. Date: Jul. 27, 2017

(54) REFILL-CONTAINER FOR REPLENISHING AND/OR RECONDITIONING AN INSULATION FLUID CONTAINED IN AN INSULATION SPACE OF AN ELECTRICAL APPARATUS

(71) Applicant: ABB Schweiz AG, Baden (CH)

(72) Inventors: Arben Elshani, Winterthur (CH); Denis Tehlar, Zurich (CH); Javier Mantilla Florez, Baden (CH); Mathias-Dominic Buergler, Wetting en (CH); Stephan Grob, Baden (CH); Thomas Diggelmann, Hori (CH)

(21) Appl. No.: 15/415,445

(22) Filed: Jan. 25, 2017

Related U.S. Application Data
(63) Continuation of application No. PCT/EP2014/066067, filed on Jul. 25, 2014.

(51) Int. Cl. H01H 33/56

(52) U.S. Cl. CPC H01H 33/56

(57) ABSTRACT

The present invention relates to a refill-container for replenishing and/or reconditioning an insulation fluid contained in an insulation space of an electrical apparatus. At least a portion of the interior of the refill-container defines a refill-fluid containment space, in which a refill-fluid comprising an organo-fluorine compound is contained. According to the invention, the refill-container further comprises an opening designed to be brought from a sealed state, in which the refill-fluid is hermetically contained in the refill-containment space, to an open state, in which the refill-fluid is allowed to flow through the opening out of the refill-containment space into the insulation space.

The present invention relates to a refill-container for replenishing and/or reconditioning an insulation fluid contained in an insulation space of an electrical apparatus as well as to an assembly comprising an electrical apparatus and a refill-container. The invention further relates to a method of replenishing and/or reconditioning an insulation fluid contained in an insulation space of an electrical apparatus.

Dielectric insulation media in liquid or gaseous state are conventionally applied for the insulation of an electrical component in a wide variety of apparatuses, such as for example switchgears, gas-insulated substations (GIS), gas-insulated lines (GIL), transformers, or other.

In medium or high voltage metal-encapsulated switchgears, for example, the electrical component is arranged in a gas-tight housing, the interior of which defines an insulating space, said insulation space comprising an insulation gas electrically insulating the housing from the electrical component. For interrupting the current in a high voltage switchgear, the insulating gas further functions as an arc extinction gas.

Recently, the use of organofluorine compounds in an insulating gas has been suggested. Specifically, WO-A-2010/142346 discloses a dielectric insulation medium comprising a fluoroketone having from 4 to 12 carbon atoms. A dielectric insulation medium of particular relevance is further disclosed in WO-A-2012/080246, relating to a medium comprising a dielectric insulation gas, which comprises a fluoroketone containing exactly 5 carbon atoms in a mixture with a dielectric insulation gas component different from said fluoroketone. Still, further WO-A-2012/080222 discloses a dielectric insulation medium comprising a hydrofluoromonoether.

Both groups of compounds have been shown to have high insulation capabilities, in particular a high dielectric strength, as well as high arc extinction capabilities. At the same time, they have a very low Global Warming Potential (GWP) and very low toxicity. The combination of these characteristics renders these organofluorine compounds highly suitable as a substitute for SF₆ (sulphur hexafluoride), which has commonly been used as a dielectric insulation medium, but which is known to have a high GWP.

However, in particular during e.g. a switching operation, which is accompanied by a high temperature increase in the insulation space, organofluorine compounds can be subject to decomposition.

In contrast to SF₆, organofluorine compounds having a low GWP, and fluoroketones in particular, do not recombine when once being decomposed. The decomposition of organofluorine compounds is particularly pronounced in arc-interrupting apparatuses, such as circuit breakers or disconnectors.

To ensure proper functioning over the electrical lifetime of the apparatus, the gas density of the organofluorine compound must be controlled and maintained above a minimum value. This task is particularly demanding for circuit breakers and disconnectors, where proper functioning has to be ensured for all switching and commutation scenarios.

Once consumed, i.e. being in a state in which proper functioning of the apparatus cannot be ensured, the gas mixture comprising decomposition products has to be replaced.

To this end, the gas mixture is removed from the insulation space, which, when in the emptied state, is opened for the filling with fresh components of the insulation fluid. This time-consuming procedure is unfeasible due to the operational dead-time during the removal and filling processes. Furthermore, the devices used for removing the consumed gas mixture as well as for filling with fresh insulation fluid components are typically costly.

The object of the present invention is thus to provide a device and a method for replenishing the insulation fluid contained in an electrical apparatus in a simple manner without interrupting operation.

The object is solved by the refill-container and the assembly defined in independent claims 1 and 30, respectively, as well as by the method defined in independent claim 36. Preferred embodiments of the refill-container, the assembly and the method, respectively, are defined in the dependent claims.

Specifically, the present invention relates to refill-container for replenishing and/or reconditioning an insulation fluid contained in an insulation space of an electrical apparatus, at least a portion of the interior of the refill-container defining a refill-fluid containment space, in which a refill-fluid comprising an organofluorine compound is contained. According to the invention, the refill-container further comprises an opening designed to be brought from a sealed state, in which the refill-fluid is hermetically contained in the refill-containment space, to an open state, in which the refill-fluid is allowed to flow through the opening out of the refill-containment space.

By providing a refill-container, an assembly and a method as defined in the independent claims, the present invention thus allows for replenishment and/or reconditioning of the insulation medium in a very straightforward manner without interrupting operation of the electrical apparatus.

As will be discussed further in the context of the assembly and of the method of the present invention, the refill-fluid is allowed to flow through the opening out of the refill-containment space and into the insulation space of the electrical apparatus, thus allowing for a simple replenishment and/or reconditioning of the insulation fluid in the electrical apparatus. As will be discussed in more detail below, the flowing of the refill-fluid can thereby be achieved passively, i.e. by self-diffusion phenomena, and/or can be supported by a force-exerting component for exerting a compressive force onto the refill-containment space.

The term “insulation fluid” as used in the context of the present invention is to be interpreted broadly and encompasses any dielectric gas or liquid. In particular, the term also encompasses any two-phase system comprising both a gaseous and a liquid phase. In particular with regard to its use for interrupting currents in a high voltage switchgear, the insulating fluid further functions as an arc extinction fluid.

According to a specific embodiment of the refill-container, the assembly and the method of the present invention, respectively, the refill-fluid contained in the refill-fluid containment space is in gaseous state down to a temperature of 15° C., preferably down to a temperature of 0° C., more preferably down to a temperature of −20° C. Since the minimum operating temperature of the electrical apparatus is typically −20° C. at least, the refill-fluid is thus gaseous at any temperature condition to which the apparatus can be subject to.

The refill-fluid contained in the refill-fluid containment space being in gaseous state, the refill-container is in any respect different from containers in which high amounts of a pure component of the insulation fluid, in particularly the organofluorine compound, are stored in liquid state, as it is the case for a liquefied gas cylinder or liquefied gas bottle.

Rather, the refill-fluid being in the gaseous state reflects a further specifically preferred concept of the present invention, according to which the refill-container is a disposable or recyclable container for single use (or a “single use container”), meaning that after a single use for replenishing and/or reconditioning the insulation fluid, the at least partially emptied container can be recycled or disposed of as solid waste. According to this concept, the refill-container can thus also be regarded a refill-cartridge.

Given the relatively low amount of refill-fluid needed for a single use, a relatively small volume of the refill-containment space can be chosen, despite of containing the refill-fluid in gaseous state. As mentioned, this is in clear distinction from a conventional liquefied gas cylinder or liquefied gas bottle, which aim at storing high amounts of a given component, rather than storing a dose for a single use.

More specifically, the refill-fluid contained in the refill-fluid containment space of the refill-container comprises a background gas, preferably selected from the group consisting of: air, an air component, in particular nitrogen or oxygen or carbon dioxide, a nitrogen oxide, and mixtures thereof. This is in further distinction over containers in which a single component of the insulation fluid is stored, as it is the case in e.g. a liquefied gas cylinder or liquefied gas bottle for storing the organofluorine compound.

In order to ensure that the refill-fluid contained in the refill-fluid containment space is in gaseous phase also at relatively low temperatures, the pressure of the refill-fluid contained in the refill-fluid containment space is below 100 bar, more preferably below 30 bar, most preferably below 20 bar.

Typically, the organofluorines used, and specifically fluoroketones having exactly five or exactly six carbon atoms, have a relatively high boiling point. Preferably, the partial pressure of the organofluorine compound in the refill-fluid is, thus, below 3 bar, more preferably below 2 bar, even more preferably below 1.5 bar, and most preferably below 1 bar.

According to embodiments, the amount of organofluorine compound contained in the refill-fluid containment space is equal or less than about 200% of the amount needed for establishing a minimum partial pressure of the organofluorine compound in the insulation space of the electrical apparatus at its minimum operating temperature. This again reflects the concept of the present invention to provide a single use container taking into account that usually not all of the organofluorine compound in the refill-fluid containment space will flow into the insulation space of the electrical apparatus.

In this regard, the minimum partial pressure of the organofluorine compound in the insulation space of the electrical apparatus at its minimum operating temperature is preferably at least 1 kPa, preferably at least 10 kPa, more preferably at least 25 kPa, most preferably at least 50 kPa.

Given the relatively low amount needed for a single use, it is further preferred that the volume of the refill-fluid containment space is below 0.1 m³, preferably below 0.05 m³ more preferably below 0.01 m³, and most preferably below 0.005 m³.

Since—as mentioned above—organofluorine compounds suitable for the present invention often have a relatively high boiling point, their partial pressure in the insulation space is preferably kept below a threshold pressure in order to ensure that no liquefaction at operating conditions occurs. According to embodiments, the maximum partial pressure of the organo-fluorine compound in the insulation space of the electrical apparatus at operating temperatures is preferably at most 100 kPa, preferably at most 80 kPa, more preferably at most 40 kPa, most preferably at most 10 kPa.

According to embodiments, the amount of organofluorine compound contained in the refill-fluid containment space is below 3 mol, more particularly below 2.5 mol, and most particularly below 2 mol. Specifically, these amounts relate to the case where the electrical apparatus is a commonly dimensioned circuit breaker and the organofluorine compound in the refill-fluid is a fluoroketone having exactly five carbon atoms and is to be contained in the refill-fluid in a proportion of about 10%, as will be discussed in more detail below.

Preferably, the container is made of aluminium and/or of steel, more preferably stainless steel, since these materials allow to achieve an efficient barrier against gas leakage.

According to embodiments, the refill-container further comprises a connection fitting for connecting the refill-container to the electrical apparatus. A connection fitting being particular preferred, its presence is not mandatory, as it is also possible to place the refill-container with its opening sealed into the insulation space initially, and to bring the opening from the sealed to the open state when needed, thereby allowing it to discharge the refill-fluid contained in the refill-fluid containment space into the insulation space.

According to a further preferred embodiment, the connection fitting is designed such to allow detachment of the refill-container from the electrical apparatus in a non-destructive manner. Thus, proper operation of the electrical apparatus is in no way affected by the replenishing and/or reconditioning of the insulation fluid. In addition, also the refill-container can be reused by refilling and reclosing the same. The providing of a recycled refill-container is advantageous from both an economic as well as an ecological point of view. In particular, the amount of waste generated can be reduced to a minimum, since the emptied refill-containers can be reused.

According to embodiments, the opening is designed to be brought from the sealed state to the open state during or after connecting the refill-container to the electrical apparatus. By allowing opening of the container during or after connection with the electrical apparatus has been established, unwanted leakage during replenishing is avoided.

In embodiments, the opening is designed such that together with a respective inlet of the electrical apparatus it forms a flow passage leading from the refill-fluid containment space into the insulation space of the electrical apparatus, thus fluidically connecting the refill-fluid containment space with the insulation space. By this design, a direct and thus efficient flowing of the refill-fluid into the insulation space is achieved. In other words, the opening of the refill-container and the inlet of the electrical apparatus together forming the flow passage are arranged coaxially.

It is specifically preferred that at a given temperature, the pressure in the refill-containment space is higher than the pressure in the insulation space, thereby directing the flow of the refill-fluid from the refill-containment space into the insulation space of the electrical apparatus.

According to a very straightforward design, the opening is designed to be in an at least partial alignment with the inlet when the refill-container is connected to the electrical apparatus. In other words, the passage through the opening of the refill-container and the passage through the inlet of the electrical apparatus are arranged coaxially, resulting in a straight flow passage leading from the refill-fluid containment space into the insulation space, thus further contributing to a very efficient flow of the refill-fluid.

As mentioned above, the fitting for connecting the refill-container to the electrical apparatus is designed such to allow detachment of the refill-container from the electrical apparatus in a non-destructive manner. In embodiments, the connection fitting comprises a threaded portion designed to match with a threaded portion of the electrical apparatus. The threaded portion of the fitting can be in the form of an outer thread matching with the threaded portion of the electrical apparatus being in the form of an inner thread, or vice versa. By this embodiment, both connection and detachment of the refill-container with the electrical apparatus can be achieved by a simple screwing operation.

According to specific embodiments, the opening comprises a seal designed to break only after connection between the refill-container and the electrical apparatus has been established, such that upon breakage of the seal the flow passage formed between the refill-fluid containment space and the insulation space is gas-tight with regard to the surrounding of the refill-container and the electrical apparatus. The seal can for example be in the form of a membrane, which is penetrated by a protrusion (or “thorn”) of the electrical apparatus when screwing the refill-container onto the electrical apparatus, thus moving the seal in direction to the thorn.

In embodiments, flowing of the refill-fluid from the refill-containment space into the insulation space can be achieved passively, i.e. by self-diffusion phenomena.

In additional or alternative embodiments, flowing of the refill-fluid can be done actively or can be supported actively, in order to allow for a faster replenishment and/or reconditioning. For this purpose, the refill-container preferably comprises a force-exerting component for exerting a compressive force onto the refill-containment space, the force-exerting component comprising a piston which is moveable in direction towards the refill-containment space.

In embodiments, the force-exerting component is pre-loaded with the compressive force and comprises a spring and/or a chamber containing a pressurized gas, the force-exerting component being designed such that the piston is held back from moving until the compressive force exceeds a counter-force exerted by the refill-fluid contained in the refill-fluid containment space.

In the case where the force-exerting component comprises a chamber containing a pressurized gas, the force-exerting component is preferably designed such to be held back from moving until the differential pressure between the chamber and the refill-fluid containment space exceeds a threshold value.

When the opening of the refill-container is brought to the open state, the pressure in the refill-fluid containment space drops, such that the differential pressure between the chamber and the refill-fluid containment space exceeds the threshold value. By the movement of the force-exerting component towards the refill-fluid containment space, the pressure in the chamber decreases until the differential pressure reaches the threshold value and movement of the force-exerting component is stopped. Overall, this allows a fast, yet controllable injection of the refill-fluid into the insulation space of the electrical apparatus.

For generating and/or augmenting the compressive force, the force-exerting component is designed to be connected to a force-loading device. In the case, where the force-exerting component comprises a chamber containing a pressurized gas, the force-loading device is source of pressurized air or is a mechanical transducer.

According to embodiments, the apparatus is a switching apparatus, in particular a circuit breaker or a disconnector.

According to further embodiments, the organofluorine compound is selected from the group consisting of: fluoroethers, in particular hydrofluoromonoethers, fluoroketones, fluoroolefins, in particular hydrofluoroolefins, and mixtures thereof.

In this regard, it is particularly preferred that the refill-fluid comprises a hydrofluoromonoether containing at least three carbon atoms. A more detailed description of the respective hydrofluoromonoethers is for example given in WO-A-2012/080222, the disclosure of which is hereby incorporated in its entirety, in particular pages 7-12, by reference.

According to further embodiments of the refill-container, the refill-fluid comprises a fluoroketone containing from four to twelve carbon atoms, preferably containing exactly five carbon atoms or exactly six carbon atoms, or a mixture thereof.

A more detailed description of the respective fluoroketones is for example given in WO-A-2010/142346 and WO-A-2012/080246, the disclosures of which are hereby incorporated in their entirety, in particular WO-A-2010/142346 pages 3-4, 8 and WO-A-2012/080246 pages 5, 11-22, by reference.

According to embodiments, the refill-fluid comprises a fluoroketone containing exactly five carbon atoms, the amount of the fluoroketone contained in the refill-fluid containment space being less than 3 kg, preferably less than 1 kg, more preferably less than 0.5 kg. The limited amount of fluoroketone according to this embodiment again reflects the preferred destination of the refill-container according to the present invention for a single use.

According to a further aspect, it is also preferred that the refill-container further comprises cooling elements. for cooling the refill-fluid containment space down to a temperature below the dew point of the refill-fluid. On the one hand, his allows to control the amount of refill-fluid to flow into the insulation space by bringing the pressure in the refill-fluid containment space to a value below the threshold value required for establishing a flow. On the other hand, this allows to avoid condensation of organofluorine compound stored in the refill-fluid containment space.

According to a further aspect, the present invention also relates to an assembly comprising
a) an electrical apparatus for the generation, transmission, distribution and/or usage of electrical energy, the apparatus comprising a housing, at least a portion of the interior of which defines an insulation space, in which an insulation fluid comprising an organofluorine compound is contained, and
b) a refill-container for replenishing the insulation fluid, at least a portion of the interior of which defines a refill-fluid containment space, in which a refill-fluid comprising an organofluorine compound is contained.

According to embodiments, the composition of the refill-fluid and the pressure in the refill-fluid containment space is such that the refill-fluid contained therein is in gaseous state down to a temperature of 15° C., preferably down to a temperature of 0° C., more preferably down to a temperature of −20° C.

The refill-container further comprises a connection fitting connecting the refill-container to the electrical apparatus, the connection fitting comprising an opening which together with a respective inlet of the electrical apparatus forms a flow passage leading from the refill-fluid containment space into the insulation space of the electrical apparatus, thus fluidically connecting the refill-fluid containment space with the insulation space.

Preferably, the refill-container is as described above. Thus, any preferred feature described in the context of the refill-container above likewise applies to the assembly, more specifically to the refill-container of the assembly.

In particular, also the refill-container of the assembly preferably comprises a connection fitting by which the refill-container and the electrical apparatus are connected to each other.

Further, the opening of the refill-container is preferably in an at least partial alignment with the inlet of the electrical apparatus.

According to embodiments, the fluid connection between the refill-fluid containment space of the refill-container and the insulation space of the electrical apparatus is gas-tight with regard to the surrounding of the assembly. Since there is no gas leaking out, the assembly of the electrical apparatus connected to the refill-container ensures replenishing and/or reconditioning the insulation medium in a very efficient manner.

According to a still further aspect, the present invention also relates to a method of replenishing and/or reconditioning an insulation fluid contained in an insulation space of an electrical apparatus, said method comprising the method elements of
providing a refill-container, at least a portion of the interior of which defining a refill-fluid containment space containing a refill-fluid comprising an organofluorine compound,
bringing an opening of the refill-container from a sealed state, in which the refill-fluid is hermetically contained in the refill-containment space, to an open state, in which the refill-fluid is allowed to flow through the opening out of the refill-containment space, and
opening an inlet of the electrical apparatus, such that the opening of the refill-container together with the inlet of the electrical apparatus forms a flow passage leading from the refill-fluid containment space into the insulation space of the electrical apparatus, thus fluidically connecting the refill-fluid containment space with the insulation space and allowing the refill-fluid to flow from the refill-fluid containment space into the insulation space.

Before bringing the opening from the sealed to the open state, the method typically comprises the further method element of connecting the refill-container to the electrical apparatus by means of a connection fitting, the connection between the refill-container and the electrical apparatus being gas-tight.

During connecting the refill-container to the electrical apparatus, also at least one decomposition product of the organofluorine compound is typically present in the insulation fluid contained in the insulation space. Since it has been found that the amount of decomposition products as well as their impact on the operability of the apparatus is neglectable, there is in a preferred embodiment, which is applicable in general to all other embodiments disclosed herein, no need for emptying the insulation space of the electrical apparatus before replenishing and/or reconditioning according to the method of the present invention is initiated.

According to a further embodiment of the method, it further comprises the method element of disconnecting the refill-container after replenishment and/or reconditioning is complete. Thus, the original volume of the insulation space is again re-established for further or continued operation of the electrical apparatus.

The invention is further illustrated by way of the attached figures, of which:

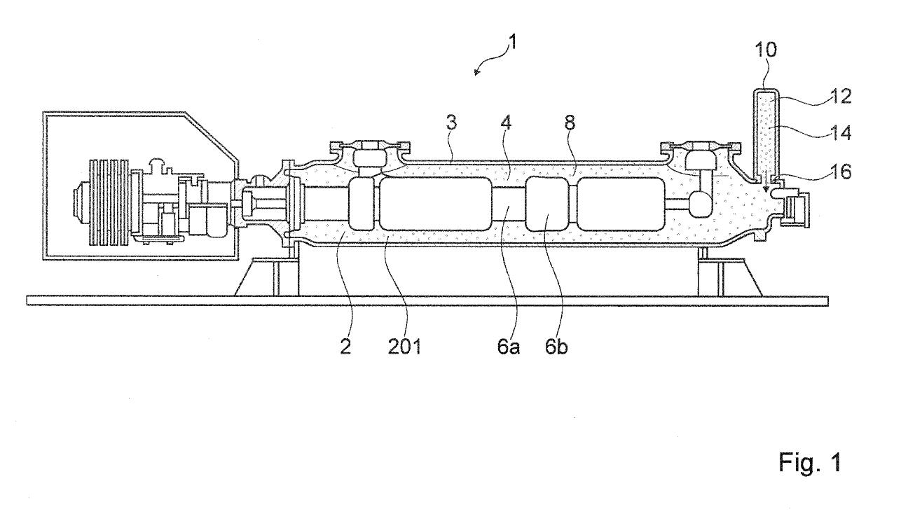

FIG. 1 shows a longitudinal section of a first assembly according to the present invention comprising a circuit breaker and a first refill-container;

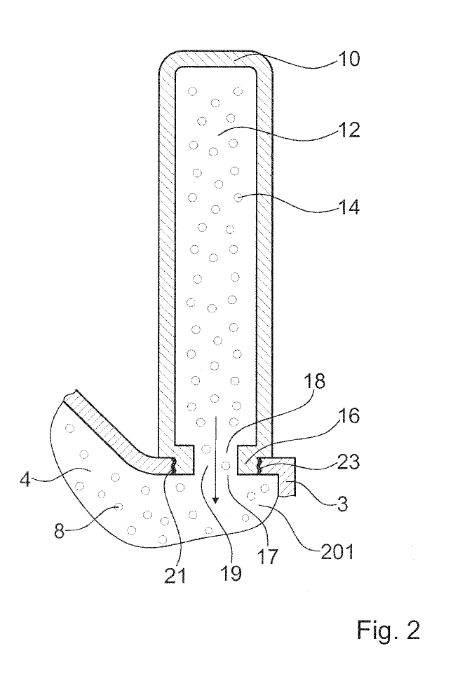

FIG. 2 shows a detail of the first refill-container shown in FIG. 1;

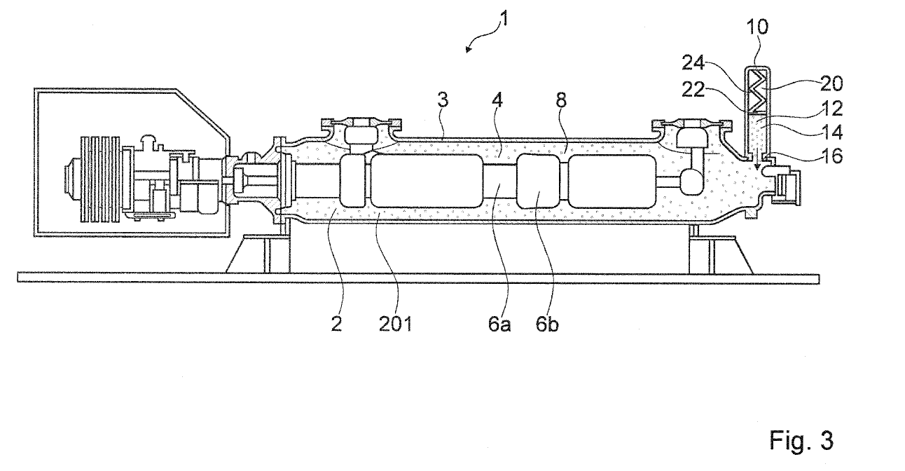

FIG. 3 shows a longitudinal section of a second assembly according to the present invention comprising a circuit breaker and a second refill-container comprising a force-exerting component; and

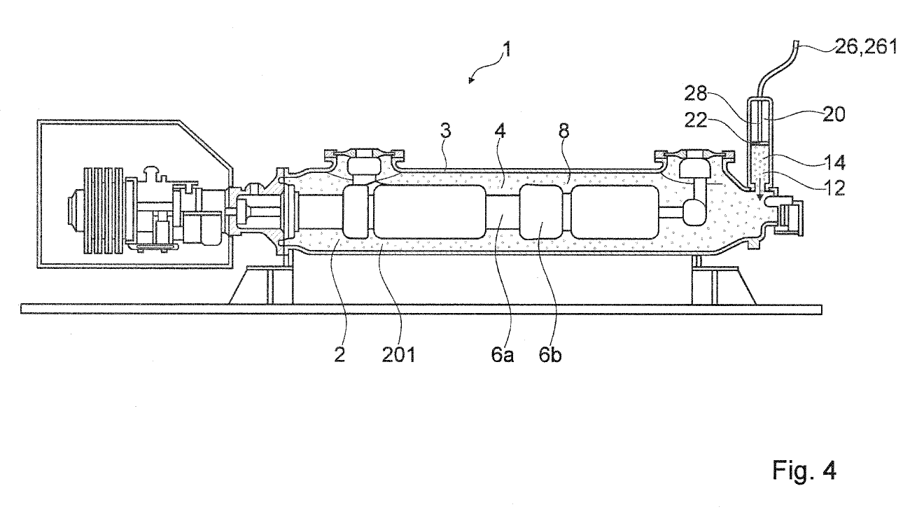

FIG. 4 shows a longitudinal section of a third assembly according to the present invention comprising a circuit breaker and a third refill-container comprising a force-exerting component, which is connected to a force-loading device.

As illustrated, the exemplary circuit breaker 201 of assembly 1 shown in the figures comprises a housing 3, a portion of the interior of which defines an insulation space 4. In the insulation space 4, two contacts 6a, 6b are arranged, one of which being moveable with respect to the other one in longitudinal direction. The contacts 6a, 6b are electrically insulated from the housing 3 by an insulation fluid 8 contained in the insulation space 4 and comprising an organofluorine compound.

The assembly 1 further comprises a refill-container 10 for replenishing the insulation fluid 8 contained in the insulation space 4 of the circuit breaker 201. The interior of the refill-container 10 defines a refill-fluid containment space 12, in which a refill-fluid 14 comprising an organofluorine compound is contained.

In the embodiment shown, the refill-container 10 is connected to the circuit breaker 2 by means of a connection fitting 16. To the connection fitting 16, an opening 18 is attributed designed to be brought from a sealed state (shown in the figures), in which the refill-fluid 14 is hermetically contained in the refill-containment space 12, to an open state, in which the refill-fluid 14 is allowed to flow through the opening 18 out of the refill-containment space 12 into the insulation space 4 of the circuit breaker 201.

In the embodiments of FIGS. 1 and 2 showing the open state, the opening 18 together with a respective inlet 17 of the circuit breaker 201 forms a flow passage 19 leading from the refill-fluid containment space 12 into the insulation space 4 of the circuit breaker 201, thus fluidically connecting the refill-fluid containment space 12 with the insulation space 4, thus allowing the refill-fluid to flow out of the refill-fluid containment space 12 into the insulation space 4, as shown in FIGS. 1 and 2 by an arrow.

As also shown in FIG. 2, the connection fitting 16 comprises a threaded portion 21 designed to match with a threaded portion 23 of the electrical apparatus 2. Specifically, the threaded portion 21 of the connection fitting 16 is in the form of an outer thread matching with the threaded portion 23 of the electrical apparatus 2.

Of the different embodiments shown in the figures, the embodiment of FIGS. 1 and 2 is devoid of any force-exerting component. According to this embodiment, the transfer of refill-fluid 14 from the refill-fluid containment space 12 is controlled by diffusion only. Once a homogenous mixture within the combined space of the insulation space 4 and the refill-fluid containment space 12 is achieved, the refill-container 10 is disconnected and the housing 3 of the circuit breaker 201 is closed in order to ensure that the reconditioned insulation fluid 8 does not leak out of the insulation space 4 of the circuit breaker 201.

The specific embodiment shown in FIG. 3 differs from the one of FIGS. 1 and 2 in that the refill-container 10 comprises a force-exerting component 20 for exerting a compressive force onto the refill-containment space 12. The force-exerting component 20 comprises a piston 22 which is moveable in direction towards the refill-containment space 12, and a respective spring 24.

By means of the spring 24, the force-exerting component 20 is pre-loaded with the compressive force. It is designed such that the piston 22 is held back from moving until the compressive force exceeds a counter-force exerted by the refill-fluid 14 contained in the refill-fluid containment space 12. In this embodiment, the refill-fluid 14 contained in the refill-fluid containment space 12 is typically liquid.

Once the opening 18 of the refill-container 10 is brought from the sealed state (not shown in the figures) to the open state, the liquid refill-fluid 14 is allowed to flow out of the refill-fluid containment space 12 and the counter-force is thereby relieved. This allows the piston 22 to move towards the refill-containment space 12 and thus to eject the refill-fluid 14 out of the refill-containment space 12 into the insulation space 4 of the circuit breaker 201 in a very fast manner.

The specific embodiment shown in FIG. 4 differs from the one of FIG. 3 in that the force-exerting component 20 is connected to a force-loading device 26 in the form of a mechanical transducer 261 designed for generating the compressive force. For this purpose, the embodiment according to FIG. 4 can comprise a rod 28 instead of a spring, said rod 28 being connected to the piston 22 in a manner to allow the force obtained from the mechanical transducer 261 to be transmitted to the piston 22, thus exerting the compressive force on the refill-fluid 14 contained in the refill-fluid containment space 12. Instead of a rod, other components for transmitting the force obtained from the mechanical transducer 261 to the piston 22 can be provided, such as a never-ending screw arrangement having an outer thread and being held by a hole or a blind hole of the refill-container wall 30 with an inner thread corresponding to the outer thread of the screw.

### LIST OF REFERENCE NUMERALS

1 assembly

2; 201 electrical apparatus; circuit breaker

3 housing

4 insulation space

6a, 6b contacts

8 insulation fluid

10 refill-container

12 refill-fluid containment space

14 refill-fluid

16 connection fitting

17 inlet

18 opening

19 flow passage

20 force-exerting component

21 threaded portion of connection fitting

22 piston

23 threaded portion of electrical apparatus

24 spring

26; 261 force-loading device

28 rod

30 refill-container wall

1. A refill-container for replenishing and/or reconditioning an insulation fluid contained in an insulation space of an electrical apparatus, at least a portion of the interior of the refill-container defining a refill-fluid containment space, in which a refill-fluid comprising an organofluorine compound is contained, wherein the refill-container further comprises an opening designed to be brought from a sealed state, in which the refill-fluid is hermetically contained in the refill-containment space, to an open state, in which the refill-fluid is allowed to flow through the opening out of the refill-containment space, wherein the opening comprises a seal designed to break only during or after connecting the refill-container to the electrical apparatus, such that upon breakage of the seal the flow passage formed between the refill-fluid containment space and the insulation space is gas-tight with regard to the surrounding of the refill-container and the electrical apparatus.

2. The refill-container according to claim 1, wherein the composition of the refill fluid and the pressure in the refill-fluid containment space is such that the refill-fluid contained therein is in gaseous state down to a temperature of 15° C.

3. The refill-container according to claim 1, wherein it is a disposable or recyclable container designed for a single use.

4. The refill-container according to claim 1, wherein the refill-fluid further comprises a background gas selected from the group consisting of air, an air component, a nitrogen oxide, and mixtures thereof.

5. The refill-container according to claim 1, wherein the pressure of the refill-fluid contained in the refill-fluid containment space is below 100 bar.

6. The refill-container according to claim 1, wherein the partial pressure of the organofluorine compound in the refill-fluid contained in the refill-fluid containment space is below 3 bar.

7. The refill-container according to claim 1, wherein the amount of organofluorine compound contained in the refill-fluid containment space is equal to or less than about 200% of the amount needed for establishing a minimum partial pressure of the organofluorine compound in the insulation space of the electrical apparatus at its minimum operating temperature.

8. The refill-container according to claim 7, wherein the minimum partial pressure of the organofluorine compound in the insulation space of the electrical apparatus at its minimum operating temperature is at least 1 kPa.

9. The refill-container according to claim 1, wherein the volume of the refill-fluid containment space is below 0.1 m³.

10. The refill-container according to claim 1, wherein the refill-container is made of aluminium and/or of steel.

11. The refill-container according to claim 1, wherein the refill container further comprises a connection fitting for connecting the refill-container to the electrical apparatus.

12. The refill-container according to claim 11, wherein the connection fitting is designed such to allow detachment of the refill-container from the electrical apparatus in a non-destructive manner.

13. The refill-container according to claim 11, wherein the connection fitting comprises a threaded portion designed to match with a threaded portion of the electrical apparatus.

14. The refill-container according to claim 1, wherein the opening is designed to be brought from the sealed state to the open state during or after connecting the refill-container to the electrical apparatus.

15. The refill-container according to claim 1, wherein the opening is designed such that together with a respective inlet of the electrical apparatus it forms a flow passage leading from the refill-fluid containment space into the insulation space of the electrical apparatus, thus fluidically connecting the refill-fluid containment space with the insulation space.

16. The refill-container according to claim 1, wherein at a given temperature the pressure in the refill-containment space is higher than the pressure in the insulation space.

17. (canceled)

18. The refill-container according to claim 15, wherein the opening is designed to be in an at least partial alignment with the inlet when the refill-container is connected to the electrical apparatus.

19. The refill-container according to claim 1, wherein the refill-container comprises a force-exerting component for exerting a compressive force onto the refill-containment space, said force-exerting component comprising a piston which is moveable in direction towards the refill-containment space.

20. The refill-container according to claim 19, wherein the force-exerting component is pre-loaded with the compressive force and comprises a spring and/or a chamber containing a pressurized gas, the force-exerting component being designed such that the piston is held back from moving until the compressive force exceeds a counter-force exerted by the refill-fluid contained in the refill-fluid containment space.

21. The refill-container according to claim 19, wherein the force-exerting component comprises a chamber containing a pressurized gas and is designed such to be held back from moving until the differential pressure between the chamber and the refill-fluid containment space exceeds a threshold value.

22. The refill-container according to claim 19, wherein the force-exerting component is designed to be connected to a force-loading device designed for generating and/or augmenting the compressive force.

23. The refill-container according to claim 22, wherein the force-loading device is a source of pressurized gas and/or is a mechanical transducer.

24. The refill-container according to claim 1, wherein the electrical apparatus being a switching apparatus.

25. The refill-container according to claim 1, wherein the organofluorine compound is selected from the group consisting of: fluoroethers, fluoroketones, fluoroolefins, and mixtures thereof.

26. The refill-container according to claim 1, wherein the refill-fluid comprises a hydrofluoromonoether containing at least three carbon atoms.

27. The refill-container according to claim 1, wherein the refill-fluid comprises a fluoroketone containing from four to twelve carbon atoms.

28. The refill-container according to claim 1, wherein the refill-fluid comprises a fluoroketone containing exactly five carbon atoms, the amount of the fluoroketone contained in the refill-fluid containment space being less than 1.5 kg.

29. The refill-container according to claim 1, further comprising cooling elements for cooling the refill-fluid containment space down to a temperature below the dew point of the refill-fluid.

30. An assembly comprising
a) an electrical apparatus for the generation, transmission, distribution and/or usage of electrical energy, said apparatus comprising a housing, at least a portion of the interior of which housing defining an insulation space, in which an insulation fluid comprising an organofluorine compound is contained, and
a refill-container for replenishing and/or reconditioning the insulation fluid, at least a portion of the interior of which refill-container defining a refill-fluid containment space, in which a refill-fluid comprising an organofluorine compound is contained,
the refill-container further comprising an opening which together with a respective inlet of the electrical apparatus forms a flow passage leading from the refill-fluid containment space into the insulation space of the electrical apparatus, thus fluidically connecting the refill-fluid containment space with the insulation space, wherein the refill-container is a disposable or recyclable container designed for a single use.

31. The assembly according to claim 30, wherein the composition of the refill-fluid and the pressure in the refill-fluid containment space is such that the refill-fluid contained therein is in gaseous state down to a temperature of 15° C.

32. The assembly according to claim 30, wherein the refill-container is a refill-container according to claim 1.

33. The assembly according to claim 30, wherein it comprises a connection fitting by which the refill-container and the electrical apparatus are connected to each other.

34. The assembly according to claim 30, wherein the opening of the refill-container is in an at least partial alignment with the inlet of the electrical apparatus.

35. The assembly according to claim 30, wherein the fluid connection between the refill-fluid containment space of the refill-container and the insulation space of the electrical apparatus is gas-tight with regard to the surrounding of the assembly.

36. A method of replenishing and/or reconditioning an insulation fluid contained in an insulation space of an electrical apparatus, said method comprising the method elements of:
providing a refill-container, at least a portion of the interior of which defines a refill-fluid containment space containing a refill-fluid comprising an organofluorine compound,
bringing an opening of the refill-container from a sealed state, in which the refill-fluid is hermetically contained in the refill-containment space, to an open state, in which the refill-fluid is allowed to flow through the opening out of the refill-containment space, and
opening an inlet of the electrical apparatus, such that the opening of the refill-container together with the inlet of the electrical apparatus forms a flow passage leading from the refill-fluid containment space into the insulation space of the electrical apparatus, thus fluidically connecting the refill-fluid containment space with the insulation space and allowing the refill-fluid to flow from the refill-fluid containment space into the insulation space, wherein
during connecting the refill-container to the electrical apparatus, also at least one decomposition product of the organofluorine compound is present in the insulation fluid contained in the insulation space.

37. The method according to claim 36, wherein the composition of the refill-fluid and the pressure in the refill-fluid containment space being such that the refill-fluid contained therein is gaseous down to a temperature of 15° C.

38. The method according to claim 36, wherein before bringing the opening from the sealed to the open state the method further comprises the method element of connecting the refill-container to the electrical apparatus by means of a connection fitting, the connection between the refill-container and the electrical apparatus being gas-tight.

39. (canceled)

40. The method according to claim 38, further comprising the method element of
disconnecting the refill-container from the electrical apparatus after replenishment and/or reconditioning of the insulation fluid is complete.

41. A refill-container for replenishing and/or reconditioning an insulation fluid contained in an insulation space of an electrical apparatus, at least a portion of the interior of the refill-container defining a refill-fluid containment space, in which a refill-fluid comprising an organofluorine compound is contained, wherein the refill-container further comprises an opening designed to be brought from a sealed state, in which the refill-fluid is hermetically contained in the refill-containment space, to an open state, in which the refill-fluid is allowed to flow through the opening out of the refill-containment space, wherein the refill-container comprises a force-exerting component for exerting a compressive force onto the refill-containment space, said force-exerting component comprising, a piston which is moveable in direction towards the refill-containment space,

42. The refill-container according to claim 1, wherein the refill-fluid comprises a background gas comprising nitrogen or oxygen or carbon dioxide.

43. The refill-container according to claim 1, wherein the pressure of the refill-fluid contained in the refill-fluid containment space is below 30 bar.

44. The refill-container according to claim 1, wherein the amount of organofluorine compound contained in the refill-fluid containment space is below 3 mol.

45. The refill-container according to claim 7, wherein the minimum partial pressure of the organofluorine compound in the insulation space of the electrical apparatus at its minimum operating temperature is at least 10 kPa.

44. The refill-container according claim 1, wherein the volume of refill-container is below 0.01 m3.

45. The assembly according to claim according to claim 30, wherein the composition of the refill-fluid and the pressure in the refill-fluid containment space is such that the refill-fluid contained therein is in gaseous state down to a temperature of 3° C.

46. The assembly according to claim according to claim 30, wherein the composition of the refill-fluid and the pressure in the refill-fluid containment space is such that the refill-fluid contained therein is in gaseous state down to a temperature of −20° C.
